(19) United States
(12) Patent Application Publication
(10) Pub. No.: US 2011/0136373 A1
(43) Pub. Date: Jun. 9, 2011

(54) DATA CABLE

(76) Inventors: Norbert Friese, Taufkirchen (DE); Martin Huber, Obing (DE)

(21) Appl. No.: 13/057,008

(22) PCT Filed: Jul. 2, 2009
(86) PCT No.: PCT/EP09/04781

§ 371 Date: Feb. 1, 2011

(30) Foreign Application Priority Data
Aug. 1, 2008 (DE) 10 2008 036 399.5

(51) Int. Cl. H01R 13/58; H01B 13/00

(52) U.S. Cl. 439/460; 156/50

(57) ABSTRACT

A data cable including an electrical line with a plurality of line leads, an electrical shield, a molded piece including first counterpart form-locking elements and a housing enclosing the molded piece, wherein the housing has a central opening. The data cable further including a plug connector disposed on an end of the data cable, wherein the plug connector is electrically connected to the shield, wherein the plug connector includes a bush that is enclosed by the molded piece. The bush includes a deep-drawn tube and a bead with second form-locking elements which with the counterpart form-locking elements form a first form-locking connection, wherein an outer contour of the molded piece and an inner contour of the central opening of the housing form a second form-locking connection.

The invention relates to a data cable as defined by the preamble to claim 1 and to a method for producing a plug connector for a data cable as defined by the preamble to claims 16 and 18.

A data cable of this kind in combination with a plug connector for producing a data transmission plug connection between a pin part and a socket part is used for instance in high-speed plug-in data bus systems of motor vehicles and is known from German Patent Disclosure DE 102 05 333 A1. The known plug connector includes a rotationally symmetrical bush, which for cost reasons is produced from a deep-drawn tube on the inner circumference of which an insulating part with a through-bore rests; a contact which receives the insulated core of a data line of the data cable is mounted in this through-bore. The data line is surrounded by a shield, embodied as a mesh-like outer conductor, which is connected electrically to the rotationally symmetrical bush of the plug connector. The deep-drawn tube has a bead, formed from a crease of the tube, which serves as a stop for a fitting piece that is embodied as a plastic injection molded part and is slipped onto the tube with a press fit and that has grooves made on its outer contour. A housing surrounds the tube and the fitting piece and, for axially fixing the housing, engages the grooves with detent and locking means.

If the data cable is embodied on the so-called “star quad” principle, with four line leads located inside the cable jacket and insulated from one another and with a shield surrounding the line leads, in the form of a mesh shield that is electrically connected to the bush of the plug connector, then it is necessary that the electrical contacts of the plug connector that are connected to the line leads and that protrude from the face end of the insulating part, be unambiguously aligned with the housing of the plug connector. To that end, during the assembly of the plug connector, the housing of the plug connector must assume an unambiguous angular position relative to the line leads of the data cable, or to contact pins or contact sockets located in the insulating part and connected to the line leads, and it must be fixed not only axially on the deep-drawn tube but also fixed on the deep-drawn tube in the circumferential direction as well, in a manner fixed against relative rotation.

It is therefore the object of the present invention to embody a data cable of the type defined at the outset, with a plug connector disposed on the end of the data cable and having a preferably rotationally symmetrical bush, such that axial fixation of the housing of the plug connector and an association, in a manner fixed against relative rotation, with an unambiguous angular position of the housing of the plug connector relative to the line leads of the data cable are assured in a simple way.

This object is attained according to the invention by a data cable having the characteristics of claim 1.

The embodiment according to the invention ensures both an axial fixation of the housing of the plug connector and an association of the housing of the plug connector with line leads of the data cable in a manner fixed against relative rotation and with an unambiguous relative angular position, by simple mechanical means and with easy assembly.

By means of the form-locking connections between the bead of the deep-drawn tube and the molded piece on the one hand and between the molded piece and the housing on the other, an unambiguous association of the housing of the plug connector with the line leads of the data cable and optionally with orientation aids disposed on the housing is created in a manner fixed against relative rotation.

Preferably, the form-locking elements of the bead comprise stamped out or cut out perforations, recesses, or a non-rotationally-symmetrical periphery of the bead.

The form-locking relative rotation prevention, based on the meshing of the form-locking elements of the bead and the counterpart form-locking elements of the molded piece, is generated only after the deep drawing of the essentially rotationally symmetrical tube that forms the bush of the plug connector, by means of stamping or cutting the form-locking elements out of the bead or in some similar way; this prevents perforations, recesses or other removals of material that might have been made before the deep drawing from weakening the material and making the deep drawing of the tube more difficult or even impossible.

To furnish the largest possible surface area of recesses, perforations or other removals of material for forming the form-locking elements on the bead, and to produce the bead in a simple way and without weakening the material, the bead extends annularly around the bush and is preferably formed by a defined compressing of the deep-drawn tube.

The essentially rotationally symmetrical bush has an inward-oriented tongue, formed in the deep drawing of the tub, that corresponds with a groove of an insulating part which is inserted into the bush and receives the line leads, or contact pins or contact sockets connected to the line leads; it is thus ensured that the insulating part can be connected to the bush only in an unambiguous relative angular position, which is the prerequisite so that the further parts of the plug connector that are to be connected to the bush are aligned in an unambiguous relative angular position with regard to the line leads of the data cable.

By means of an encircling crimp mounted on the deep-drawn tube, an increase in the retention forces of the further parts of the plug connector that are to be connected to the bush is attained.

The molded piece can either be attached to the bush in mold injection by means of a high-pressure injection molding process, or it can be embodied as an injection molded part that is slipped or press-fitted onto the bush; the molded piece embodied as an injection molded part has a central opening into which the bush is inserted in such a way that the recesses, perforations, or the peripheral contour of the bead are press-fitted into complementary protrusions or contours.

In the extrusion-coating of the sleeve, given a suitable length of the molded piece, an additional tension relief of the data cable is simultaneously provided, and protruding individual stranded wires of the shield are additionally covered.

When a molded piece embodied as an injection molded part is used, to ensure an unambiguous relative angular position between the line leads of the data cable and the molded piece, a mechanical code is preferably employed, with the aid of which the molded piece embodied as an injection molded part can be slipped onto the bead only in a specified alignment. This mechanical code can be produced by means of a predeterminable structuring of the recesses, perforations or peripheral contour of the bead, and by means of a counterpart structure adapted to the predetermined structure of the central opening of the molded piece. For example, the recesses, perforation or peripheral contour of the bead can be provided with an additional notch or peripheral flattening, and the central opening of the molded piece can be provided with a tongue adapted to the notch, or with a rib adapted to the peripheral flattening, which allows the molded piece embodied as an injection molded part to be connected to the deep-drawn tube only in the predetermined direction and thus in an unambiguous relative angular position.

The outer body of the plug connector is formed by an outer housing, which has a central opening the inner surface of which has a recess, perforation, or asymmetrical contour that is adapted to an asymmetrical contour of the outer surface of the molded piece so that the directionally oriented relative rotation prevention extends from the line leads to the housing.

In a preferred feature, the molded piece is embodied in the shape of a cube or oblong block, and one corner of the square or rectangular outer surface of the molded piece is chamfered, while the inner surface of the central opening of the housing has a chamfer corresponding to it.

Preferably, the housing is fixed on the molded piece in a relative angular position that is predetermined by the recess, perforation or asymmetrical contour, and the molded piece is slipped on and fixed by means of a radially adjustable securing element.

In this way, the outer housing is fixed with regard to the line leads in a manner fixed against relative rotation, and thus an axial and circumferentially fixed association between the outer housing and the line leads of the data cable is ensured via the molded piece, the bead of the bush, the inward-oriented tongue of the bush, and the insulating part provided with a groove; this is absolutely essential particularly in multi-lead systems, in contrast to a single-lead data cable with a data line, in order to ensure an unambiguous relative angular position between the line leads of the data cable and the outer housing.

In a further feature, a coding device is disposed on the free end of the plug connector, which end is opposite from the cable lead-in into the plug connector; the coding device ensures a correct alignment of the plug connector with a counterpart plug connector for the sake of correct line connection, and in particular, the coding device comprises ribs that protrude from the periphery of the face end of the insulating part and rest on the inner circumference of the bush so that a counterpart plug connector can be coupled to the plug connector only in an unambiguous relative angular position.

As an additional aid in orientation for aligning the plug connector with a counterpart plug connector or a complementary plug or outlet part, a bar code, color or shape code or the like can be disposed on the outer surface of the housing.

Methods for producing a plug connector for a data cable having an electrical line with a plurality of line leads and an electrical shield, in which plug connector an electrically conductive metal material is deep drawn into a tube, and the deep-drawn tube forming a substantially rotationally symmetrical bush is connected electrically conductively to the shield, can be learned from the characteristics of claims 16 and 18, and advantageous features of the production methods according to the invention can be learned from the characteristics of dependent claims 17 and 19-23.

Exemplary embodiments of the invention are shown in the drawings and are described in further detail below in conjunction with the drawings. Shown are:

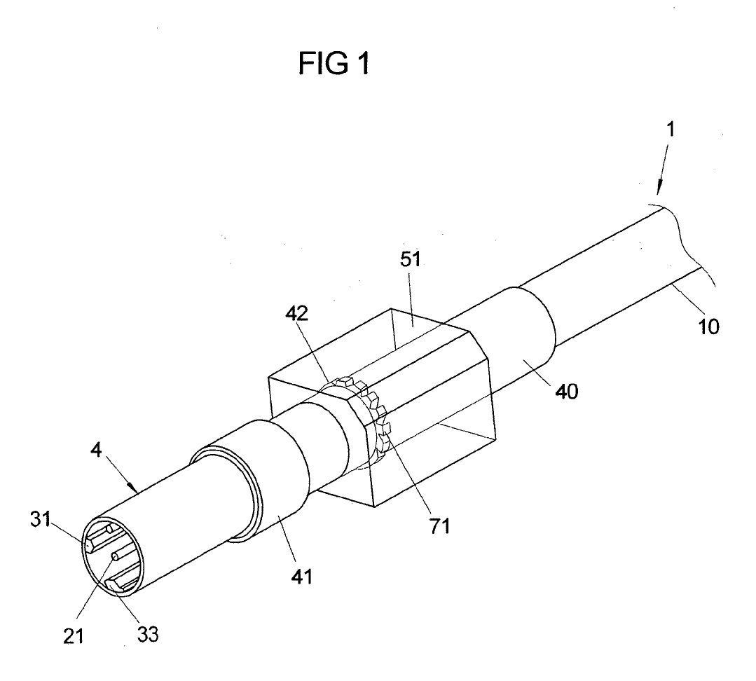

FIG. 1, a perspective view of the end region of a data cable with a bush of a plug connector and a bead with form-locking elements embodied on the bead;

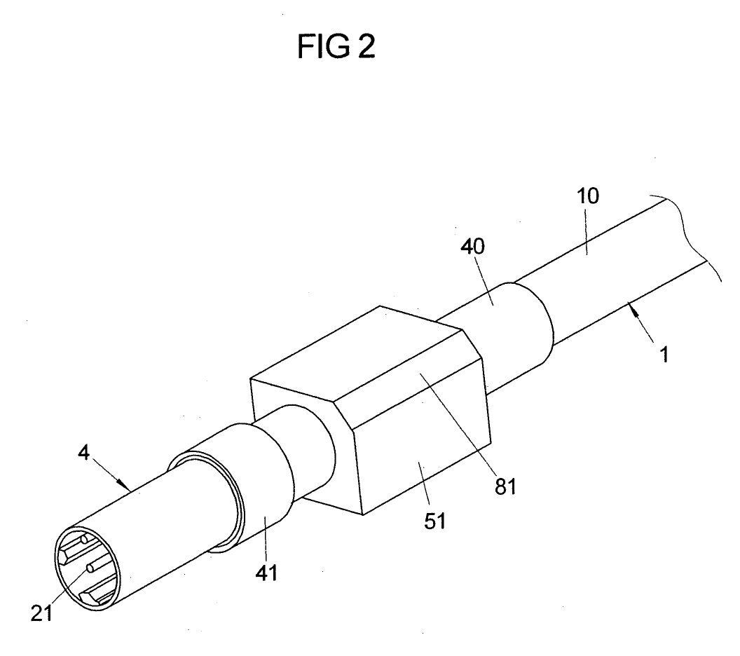

FIG. 2, a perspective view corresponding to FIG. 1, with a molded piece connected to the bush in form-locking fashion and fixed against relative rotation;

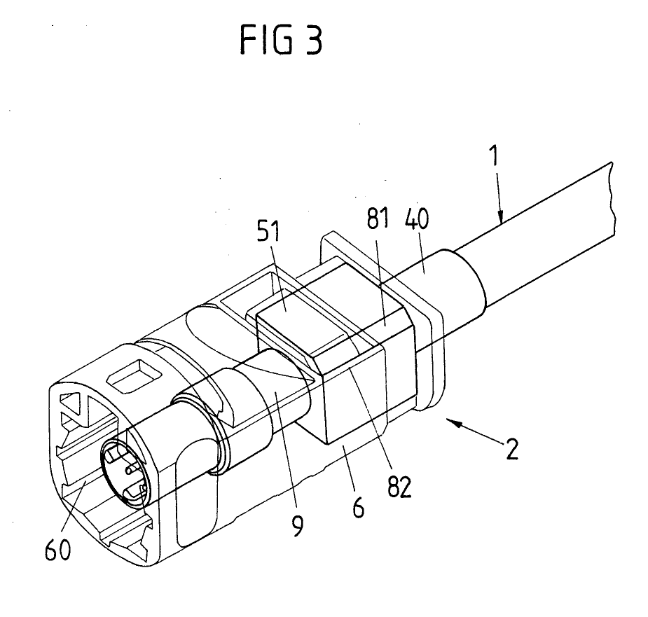

FIG. 3, a perspective view corresponding to FIG. 2, with a housing of the plug connector connected to the bush and the molded piece in a manner fixed against relative rotation;

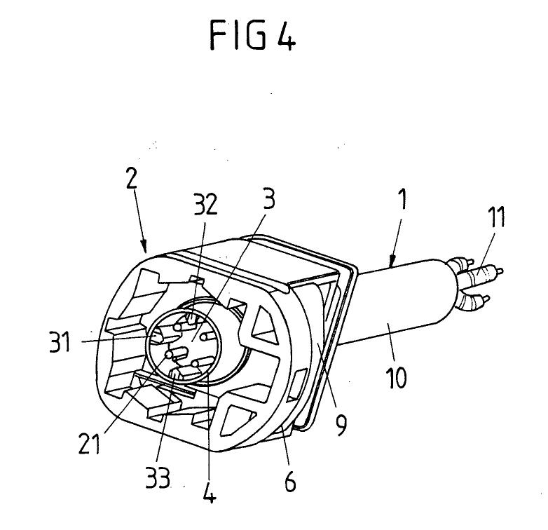

FIG. 4, a perspective top view on the face end of the plug connector, with an insulating part that is inserted into the bush and has contact pins and ribs for mechanical coding;

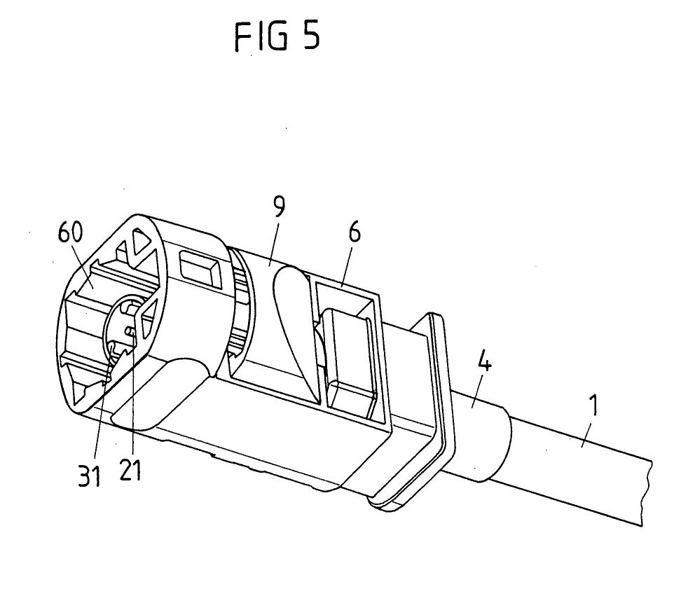

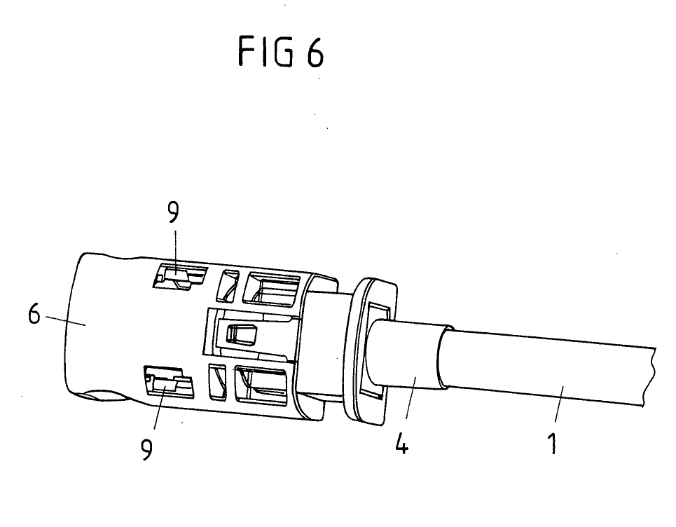

FIGS. 5 and 6, perspective front and rear views of the plug connector connected to the data cable;

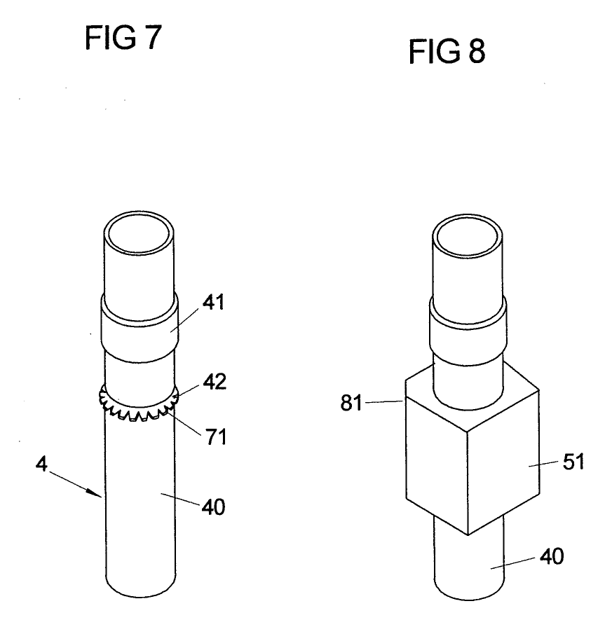

FIG. 7, a perspective view of a bush that comprises a deep-drawn tube and stamped out recesses, the deep-drawn tube having an compressed bead;

FIG. 8, a perspective view of the bush of FIG. 7, with a molded piece surrounding the bead and having a corner chamfer;

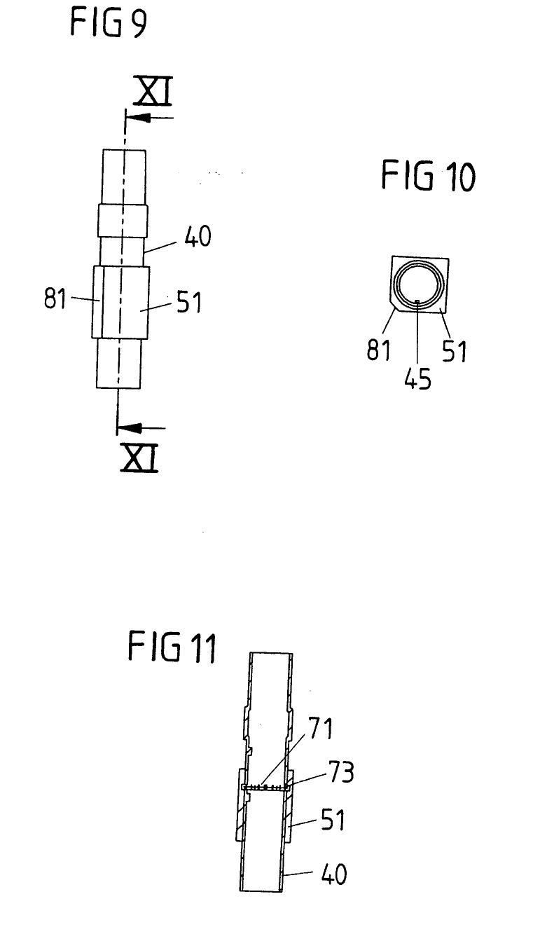

FIG. 9, a side view of the bush with the molded piece of FIG. 8;

FIG. 10, a top view of the bush with the molded piece of FIG. 8;

FIG. 11, a section through the bush and the molded piece along the line VIII-VIII in FIG. 8;

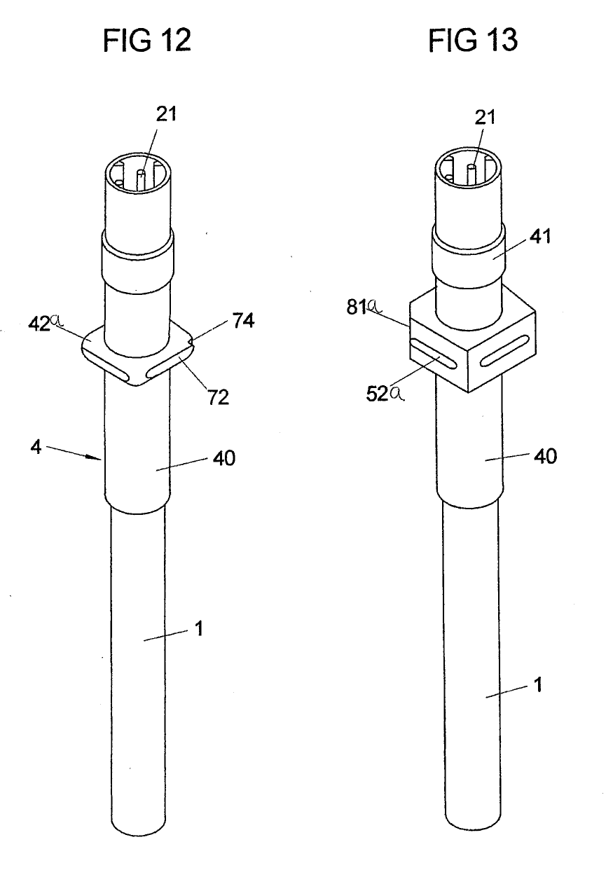

FIG. 12, a perspective view of the end region of a data cable having an essentially rotationally symmetrical bush, a compressed bead with a non-rotationally-symmetrical outer contour, and contact pins;

FIG. 13, a perspective view of the end region of a data cable having a bush as in FIG. 12 and a short molded piece, surrounding the bead, with a corner chamfer;

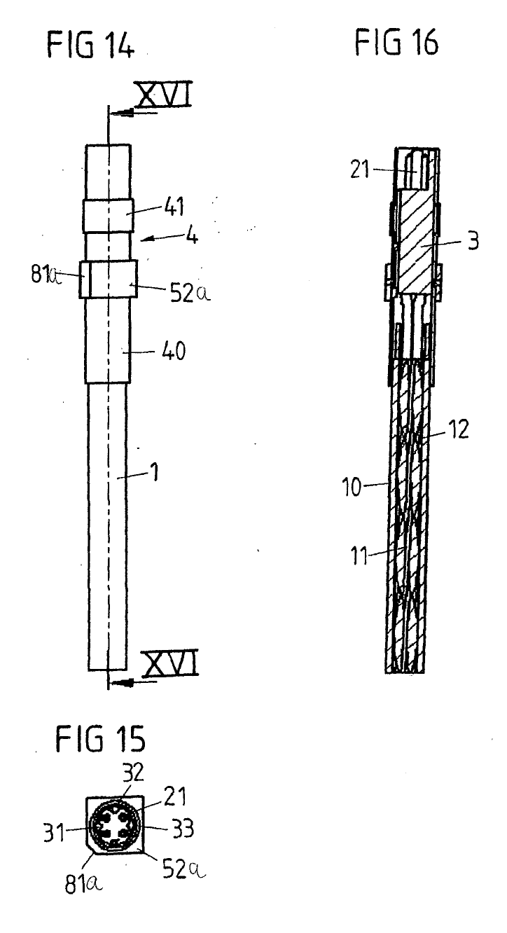

FIG. 14, a side view of the bush with the molded piece of FIG. 13;

FIG. 15, a top view of the bush with the molded piece of FIG. 14;

FIG. 16, a section through the bush and the molded piece along the line XVI-XVI in FIG. 14;

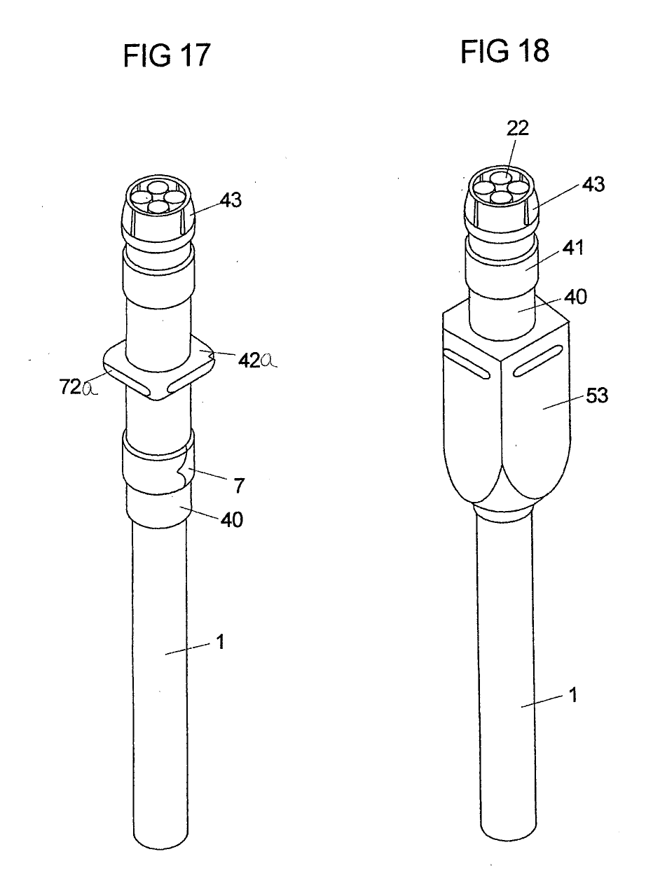

FIG. 17, a perspective view of the end region of a data cable having an essentially rotationally symmetrical bush, a compressed bead with a non-rotationally-symmetrical outer contour, and contact sockets as well as a encircling crimp;

FIG. 18, a perspective view of the end region of a data cable having a bush as in FIG. 17 and a long form-locking element, surrounding the bead, with a corner chamfer and tension relief;

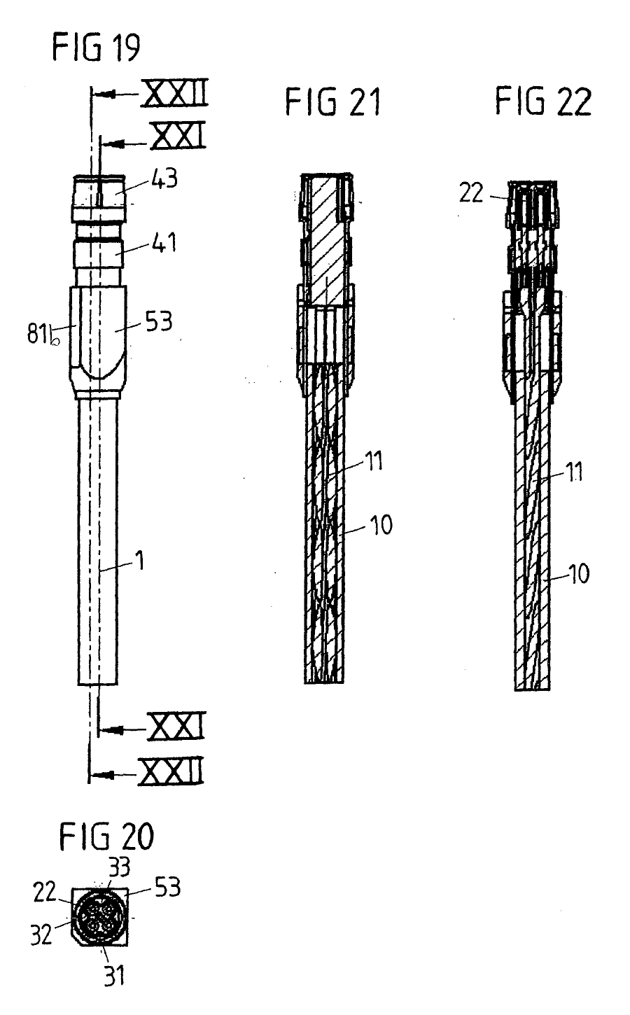

FIG. 19, a side view of the bush with the molded piece of FIG. 18;

FIG. 20, a top view of the bush with the molded piece of FIG. 19;

FIG. 21, a section through the bush and the molded piece along the line XXI-XXI in FIG. 19; and

FIG. 22, a section through the bush and the molded piece along the line XXII-XXII in FIG. 19.

The principle of the invention of a form-locking relative rotation preventer for a molded piece 51, with an essentially rotationally symmetrical bush 4 produced from a deep-drawn tube 40 and with a housing 6, for form-locking axial fixation and in the circumferential direction in an unambiguous relative angular position to the line leads of a data cable, for a plug connector 2 disposed on the end of the data cable 1, will now be described in conjunction with FIGS. 1-6. As a result of the form-locking relative rotation preventers between the bush 4, the molded piece 51 and the housing 6, the housing 6 of the plug connector 2 is aligned and fixed in an unambiguous relative angular position with regard to contact pins 21 (or contact sockets 22 in FIGS. 17-22) inserted into bores of an insulating part 3, which is aligned by means of a tongue-and-groove guide in the circumferential direction and is disposed in fixed fashion in the bush 4, and is thus aligned and fixed with regard to the line leads of the data cable 1. Thus, unlike what in this respect is an unproblematic coaxial cable, even with a non-rotationally-symmetrical conductor arrangement of the data cable 1, an unambiguous association of the housing 6 with the line leads of the data cable is ensured, so that misconnections on connecting the plug connector 2 to a counterpart plug connector can be precluded.

FIG. 1, in a perspective view, shows the end piece of a data cable 1, whose cable jacket 10 surrounds both a plurality of line leads, disposed non-rotationally-symmetrically, and a shield. The line leads, connected to contact pins 21, are disposed in insulated fashion in a bush 4, while the shield is connected to the bush 4, which comprises an electrically conductive material. The bush 4 comprises a deep-drawn tube 40, which has a cylindrical attachment 41, and a bead 42, which is embodied on the tube 40 by defined compressing. The annularly closed bead 42 is provided with form-locking elements 71 embodied as recesses, which are stamped or cut into the bead 42 after the deep drawing process for producing the deep-drawn tube 40 and after the defined compressing of the bead 42, and they furnish part of a form-locking connection for form-locking relative rotation prevention for a molded piece 51 whose outlines are shown schematically in FIG. 1.

FIG. 2, in a perspective view, shows the bush 4 with the molded piece 51, connected to the bush 4 in form-locking fashion and in a manner fixed against relative rotation. In a first embodiment, the molded piece 51 is mounted as a extrusion coating directly on the bush 4 as follows: the bush 4 is placed in the mold of an injection molding machine such that it is aligned with the tongue embodied in the deep-drawn tube 40, and a plastic, in particular an elastomer, is then injected into the mold.

Alternatively, in a second embodiment, the molded piece 51 can be produced as a separate injection molded part, which has a central opening that is slipped onto the bush 4 such that the bead 42, provided with the form-locking elements 71, is press-fitted into the complementary central opening in the molded piece 51. In this process, the tongue embodied in the deep-drawn tube 40 likewise serves to define the mutual alignment of the deep-drawn tube 40 and the molded piece 51. Alternatively or in addition, by means of a mechanical code, such as an irregular contour of the form-locking elements 71 of the bead 42 and a corresponding contrary contour of the counterpart form-locking elements of the molded piece 51, an unambiguous association between the bush 4 and the molded piece 51 can be attained, so that the line leads, introduced into the bush 4 in a defined alignment, are aligned radially with the molded piece 51 in a predetermined manner.

On its outer surface, the molded piece 51, which in this embodiment is in the form of an oblong block of square cross section, has a chamfered corner 81, for forming a further form-locking element. This further form-locking element 81 serves to establish a second form-locking connection with an outer housing 6, which is shown in outlines in FIG. 3 and which with a central recess 60 is slipped axially onto the bush 4 and the molded piece and secured axially by means of a radially adjustable securing element 9. In its central opening 60, the housing 6 has, as a counterpart form-locking element 82, a contour adapted to the contour of the form-locking element 81 disposed on the outside of the molded piece 51, so that a further form-locking relative rotation preventer between the molded piece 51 and the housing 6 and thus an unambiguous angular association with the line leads of the data cable 1 or the contact pins 21 or contact sockets 22 of the plug connector 2 is produced.

FIG. 4, in a perspective top view of the face end of the plug connector 2, shows the housing 6, provided with a contoured interior, and the face end of the bush 4 with the insulating part 3 disposed in it; four contact pins 21 protrude from the face end of the insulating part and are inserted into bores in the insulating part 3 and are connected to the line leads of the data cable 1. To ensure that the plug connector 2 can be introduced into the counterpart of a further plug connector in only one position, three ribs 31, 32, 33, contacting the inner circumference of the bush 4 and forming the corner points of an equilateral triangle, protrude from the periphery of the face end of the insulating part 3 and act as a coding device.

The perspective front and rear views of the plug connector 2 illustrate the disposition and function of the securing element 9, by the radial displacement of which the housing is fixed axially on the bush 4 and the molded piece 51.

FIG. 7, in a perspective view, shows the deep-drawn tube 40 of the bush 4, with the annular bead 42 embodied by defined compressing of the deep-drawn tube 40, and also shows the form-locking elements 71 embodied in the form of recesses in the bead by stamping or cutting before the connection to the molded piece 51. The molded piece 51 is then formed integrally onto the deep-drawn tube 40 by being extrusion-coated onto the deep-drawn tube 40 by means of a high-pressure injection molding process.

Alternatively, the bush 4 is introduced into the central opening of a molded piece 51, embodied as an injection molded part, in such a way that the form-locking elements 71 of the bead 42 are press-fitted into the complementary counterpart form-locking elements of the central opening of the molded piece 51. In both variant embodiments, form-locking relative rotation prevention is established between the bush 4 and the molded piece 51.

The bush 4 with the molded piece 51 connected to it in form-locking fashion and fixed against relative rotation is shown in FIGS. 9-11 in a side view, a top view, and a section along the line XI-XI of FIG. 9, respectively.

The sectional view in FIG. 11 illustrates the axial form lock between the bead 42 and the central opening of the molded piece 51, as well as the radial form lock between the form-locking elements 71 embodied on the bead 42 and the counterpart form-locking elements 73 embodied in the central opening of the molded piece.

The top view on the bush 4 of FIG. 10 shows the tongue 45, embodied on the cylindrical inner surface of the deep-drawn tube 40, onto which tongue the complementary groove of the insulating part 3 is slipped as shown in FIGS. 4-6.

In FIGS. 12-22, two variant embodiments are shown, for a pin and socket form of the plug connector, respectively; elements of the data cable 1 and plug connector 2 matching those of the drawings described above are identified by the same reference numerals, so to avoid repetition, the reader is referred to the above description.

FIG. 12 shows a plug connector, embodied as a contact pin connection, with contact pins 21 and a bead 42 whose form-locking elements are embodied as a square outer contour 72 of the bead 42; this contour is produced by suitable cutting or stamping and is provided with a notch 74, as an orientation element, for angular association of the bead 42 with the insulating part 3 inserted into the opening in the deep-drawn tube 40 on the one hand and with the molded piece 52 on the other. The molded piece 52, which in this embodiment is short, is either integrally injection molded onto the deep-drawn tube 40 in the vicinity of the bead 42, as described above, or slipped as an injection molded part onto the deep-drawn tube 40.

FIG. 13 shows a side view on the end piece of the data cable 1 with the bush 4 and the molded piece 52, whose chamfered outer edge is embodied as a form-locking element 81 for making a second form-locking connection with the housing 6 in FIGS. 3-6. The data cable 1, in the section shown in FIG. 16, has a cable jacket 10 having both the twisted line leads 11, which are provided with a cable insulation, and an electrical shield 12, which is connected to the bush 4. The insulated line leads 11 provided with contact pins 21 are passed through precise longitudinal bores in the insulating part 3, which is inserted into the deep-drawn tube 40 of the bush 4 in a predetermined orientation.

FIG. 14, in a top view on the bush 4, shows the contact pins, arranged on the star-quad principle, and the inward-oriented ribs 31-33 of the insulating part 3 for mechanical coding for an unambiguous angular position between the line leads 11, or contact pins 21, and the bush 4, or between the molded piece 52 connected to the bush 4 in form-locking fashion and fixed against relative rotation and thus with the housing 6, likewise connected to the molded piece 52 in form-locking fashion and fixed against relative rotation, as shown in FIGS. 3-6.

FIG. 17, in a perspective view, shows a plug connector, embodied as a contact socket connector, with contact sockets 22, a cylindrical-annular attachment 41, a bead 42 formed by compressing of the deep-drawn tube 40 and having a square outer contour as a form-locking element 72 corresponding to the form-locking element 72 of FIG. 12, and a socket 43 surrounding the contact pins 22. On its chamfered or rounded corners, the square outer contour 72 of the bead 42, produced by suitable cutting or stamping, has a notch 74 for angular association of the bead 42 with both the insulating part 3, inserted into the opening of the deep-drawn tube 40, and the molded piece 53, which is injection molded onto or slipped as an injection molded part onto the deep-drawn tube 40 in the vicinity of the bead 42.

To increase the force absorption in the axial direction, a encircling crimp 7 is placed around the deep-drawn tube 40 and is connected in form-locking fashion to the injection-molded or slipped-on molded piece 53 in FIG. 18.

FIG. 18 shows a side view of the end piece of the data cable 1 with the bush 4 and the bead 42 onto which the molded piece 53 is injection molded for slipped on as an injection molded part. The molded piece 53, which in this embodiment is long, is chamfered on its end toward the data cable 1. In addition, the molded piece 53 has a chamfered outer edge for forming a form-locking element 81, which with a correspondingly chambered inner surface 82 corresponds to the central opening 60 of the housing 6 in FIGS. 3-6.

The end of the data cable 1 and of the plug connector 2, shown in FIGS. 21 and 22 in sections along the lines XXI-XXI a and XXII-XXII of FIG. 19, the cable jacket 10 with the line leads 11, disposed in twisted fashion in it and provided with a cable insulation, is shown as well as an electrical shield 12, which is connected to the bush 4. The insulated line leads of the data cable 1 that are connected to contact sockets 22 are inserted through the longitudinal bores of the insulating part 3, which is inserted into the deep-drawn tube 40 of the bush 4 in a predetermined orientation, by means of the tongue-and-groove association between the cylindrical inner surface of the bush 4 and of the insulating part 3.

FIG. 20, in a top view on the bush 3, shows the contact sockets 22, arranged on the star quad principle, and the inward-oriented ribs 31-33 of the insulating part 3 for mechanical coding and thus for unambiguous angular association between the line leads 11 of the data cable 1 or the contact sockets 22 and the bush 4, or the molded piece 53 connected to the bush 4 in form-locking fashion and fixed against relative rotation and thus the also with the molded piece 53 in form-locking fashion and fixed against relative rotation via the form-locking element 81 of the molded piece 53 and via the corresponding counterpart form-locking element 82 of the housing 6 of FIGS. 3-6.

1-21. (canceled)

22. A data cable comprising:
an electrical line with a plurality of line leads;
an electrical shield;
a molded piece comprising first counterpart form-locking elements;
a housing enclosing said molded piece, wherein said housing has a central opening;
a plug connector disposed on an end of said data cable, wherein said plug connector is electrically connected to said shield, wherein said plug connector comprises a bush that is enclosed by said molded piece, said bush comprises:
a deep-drawn tube;
a bead with second form-locking elements which with said counterpart form-locking elements form a first form-locking connection; and
wherein an outer contour of said molded piece and an inner contour of said central opening of said housing form a second form-locking connection.

23. The data cable as defined by claim 22, wherein said second form-locking elements of said bead comprise stamped out or cut out perforations, recesses, or a non-rotationally-symmetrical periphery of said bead.

24. The data cable as defined by claim 22, wherein said bead extends annularly around said bush.

25. The data cable as defined by claim 24, wherein said bead is formed by a defined compressing of said deep-drawn tube.

26. The data cable as defined by claim 22, further comprising an insulating part inserted into said bush and receiving line leads or contact pins or contact sockets that are connected to said plurality of line leads; and
wherein said bush comprises an inward-oriented tongue extending in a longitudinal direction of said bush and extends into said groove of said insulating part.

27. The data cable as defined by claim 22, further comprising an encircling crimp mounted on said deep-drawn tube.

28. The data cable as defined by claim 22, wherein said molded piece is applied to said bush in mold injection by a high-pressure injection molding process.

29. The data cable as defined by claim 22, wherein said molded piece is an injection molded part and is attached or press-fitted onto said bush.

30. The data cable as defined by claim 23, wherein said molded piece is an injection molded part and is attached or press-fitted onto said bush.

31. The data cable as defined by claim 30, wherein said molded piece has a central opening into which said bush is inserted in such a way that said recesses, said perforations, or said periphery of said bead are press-fitted into complementary protrusions or contours of said molded piece.

32. The data cable as defined by claim 30, wherein said recesses, said perforations or said periphery of said bead are structured in such a way, and a central opening of said molded piece comprises a counterpart structure adapted to said recesses, said perforations or said periphery of said bead in such a way that said molded piece embodied as an injection molded part is connectable to said bush only in a predetermined radial alignment.

33. The data cable as defined by claim 22, wherein an outer surface of said molded piece has a recess, perforation, or asymmetrical contour as a form-locking element, and an inner surface of said housing has a contour, as a second counterpart form-locking element, adapted to said recess, said perforation or said asymmetrical contour of said outer surface of said molded piece; and said second counterpart form-locking element is attached onto said molded piece, or onto said bush and said molded piece, in a predetermined radial alignment and is fixed on said molded piece by a radially adjustable securing element.

34. The data cable as defined by claim 22, further comprising a coding device disposed on a free end of said plug connector that is located opposite a cable lead-in into said plug connector.

35. The data cable as defined by claim 34, wherein said coding device comprises ribs protruding from a periphery of a face end of an insulating part and contacting an inner circumference of said bush, wherein said insulating part is inserted into said bush and receives said plurality of line leads or contact pins or contact sockets that are connected to said plurality of line leads.

36. The data cable as defined by claim 22, further comprising an aid in orientation disposed on an outer surface of said housing for aligning said plug connector with a counterpart plug connector or a complementary plug part or socket part.

37. The data cable as defined by claim 36, wherein said aid in orientation is in the form of a bar code, color code or shape code.

38. A method for producing a plug connector for a data cable comprising an electrical line with a plurality of line leads and comprising an electrical shield, the method comprising:
deep-drawing an electrically conductive metal material into a deep-drawn tube forming a bush;
connecting said deep-drawn tube electrically conductively to said electrical shield;
compressing said deep-drawn tube for forming an annular bead;
stamping out or cutting out recesses and/or perforations and/or peripheral parts from said annular bead;
inserting said annular bead in an injection mold and filling said mold with a plastic for forming a molded piece;
attaching to said molded piece a prefabricated housing comprising a central opening that is adapted to an outer contour of said molded piece and that produces at least a radial form lock with said molded piece; and
fixing said housing in an axial direction on said molded piece.

39. The method as defined by claim 38, further comprising:
forming an inward-oriented tongue in said deep-drawing of said tube;
aligning said deep-drawn tube relative to said tongue, on placement of at least said annular bead of said deep-drawn tube in an injection mold, in such a way that an unambiguous relative position is established between an outer contour of said molded piece and said tongue.

40. The method as defined by claim 38, further comprising mounting an encircling crimp on said deep-drawn tube.

41. The method as defined by claim 39, further comprising:
producing a cylindrical insulating part with bores for receiving said plurality of line leads, or contact pins or contact sockets connected to said plurality of line leads, and with a groove extending in a longitudinal direction of an outer surface of said cylindrical insulating part;
inserting said cylindrical insulating part into said bush in such a way that said tongue of said deep-drawn tube is inserted into said groove of said cylindrical insulating part.

42. The method as defined by claim 38, further comprising:
producing an asymmetrical contour on an outer surface of said molded piece;
producing a contour on an inner surface of said central opening of said housing that is adapted to said asymmetrical contour of said outer surface of said molded piece, and attaching said housing onto said molded piece in a radial alignment predetermined by said asymmetrical contours; and
radially adjusting a radially adjustable securing element mounted on an outer surface of said housing on said molded piece.

43. A method for producing a plug connector for a data cable comprising an electrical line with a plurality of line leads and comprising an electrical shield, the method comprising:
deep-drawing an electrically conductive metal material into a deep-drawn tube forming a bush;
connecting said deep-drawn tube electrically conductively to said electrical shield;
compressing said deep-drawn tube for forming an annular bead;
stamping out or cutting out recesses and/or perforations and/or peripheral outer contours from said annular bead;
producing a molded piece, embodied as an injection molded part, with a central opening;
attaching said central opening of said molded piece onto said deep-drawn tube in such a way that said recesses, said perforations and/or said peripheral outer contours of said annular bead are press-fitted into complementary parts of said central opening of said molded piece.

44. The method as defined by claim 43, further comprising:
forming an inward-oriented tongue in said deep-drawing of said tube;
aligning said deep-drawn tube relative to said tongue, on placement of at least said annular bead of said deep-drawn tube in a tool for attaching on said central opening of said molded piece, in such a way that an unambiguous relative position is established between an outer contour of said molded piece and said tongue.

45. The method as defined by claim 44, further comprising:
forming an inward-oriented tongue in said deep-drawing of said tube;
providing said recesses, said perforations or said peripheral outer contours stamped or cut into said annular bead are provided with a mechanical code which establishes an unambiguous relationship between said tongue and said recesses, perforations or peripheral outer contours such that said central opening of said molded piece can be attached on only in a radial alignment with said annular bead.

46. The method as defined by claim 43, further comprising mounting an encircling crimp on said deep-drawn tube.

47. The method as defined by claim 44, further comprising:
producing a cylindrical insulating part with bores for receiving said plurality of line leads, or contact pins or contact sockets connected to plurality of line leads, and with a groove extending in a longitudinal direction of an outer surface of said cylindrical insulating part;
inserting said cylindrical insulating part into said bush in such a way that said tongue of said deep-drawn tube is inserted into said groove of said cylindrical insulating part.

48. The method as defined by claim 43, further comprising:
producing an asymmetrical contour on an outer surface of said molded piece;
producing a contour on an inner surface of said central opening of said housing that is adapted to said asymmetrical contour of said outer surface of said molded piece, and
attaching said housing onto said molded piece in a radial alignment predetermined by said asymmetrical contours; and
radially adjusting a radially adjustable securing element mounted on an outer surface of said housing on said molded piece.
